(19) United States
(12) Patent Application Publication
(10) Pub. No.: US 2018/0153340 A1
(43) Pub. Date: Jun. 7, 2018

(54) Micro-Active Thermoelastomer Heated Food Accessories

(71) Applicants: Victor Viner, Northfield, IL (US); Gil Cavada, Wauconda, IL (US); David Carhart, Cary, IL (US); Mark Schwartz, Wauconda, IL (US)

(72) Inventors: Victor Viner, Northfield, IL (US); Gil Cavada, Wauconda, IL (US); David Carhart, Cary, IL (US); Mark Schwartz, Wauconda, IL (US)

(21) Appl. No.: 15/620,416

(22) Filed: Jun. 12, 2017

Related U.S. Application Data
(60) Provisional application No. 62/431,400, filed on Dec. 7, 2016.

(51) Int. Cl. A47J 36/02; B65D 81/34

(52) U.S. Cl. CPC A47J 36/027; B65D 2581/3483; B65D 81/3453

(57) ABSTRACT

Microwave safe accessories heat up without melting or burning the user and will use conduction to keep food and liquids hot/warm. Specifically, the disclosure relates to a thermoplastic elastomer that includes microwave activated materials (such as graphite or carbon black). The thermoplastic elastomer can include an overmold, which can be inert (e.g. Santoprene, TipSiv, or the like) or can also be combined with microwave activated materials.

### FIELD OF THE DISCLOSURE

The present disclosure relates generally to a composition and structure for cooking implements requiring a sustained amount of heat at a desired level for foodstuffs. More specifically, the present disclosure is directed towards a composition combining thermoelastomers (e.g. polypropylene, polyethylene, or similar materials) and microwave activated material (e.g. carbon/graphite, iron, copper, other metals, etc.) for receiving a dielectric (e.g., microwave) energy source and subsequently releasing such energy on a controlled basis to foodstuffs and/or containers holding foodstuffs as a part of ordinary culinary preparation and presentation.

### BACKGROUND OF THE INVENTION

Use of microwave ovens for heating food for cooking or reheating previously cooked foods is a very prevalent practice. Typically containers made from plastic, paper, ceramic or glass are commonly utilized in a microwave oven, since these materials are transparent to microwave energy and the energy is absorbed by the objects inside the container which are thus heated. However, such materials are not effective thermal conductors for heating in a microwave and releasing that heat to food after being removed from the microwave.

Metal is not conventionally considered an acceptable substitute. Use of metal inside a microwave oven is not an accepted practice since bare metal can reflect the microwaves back to the magnetron inside the microwave oven resulting in damage to the magnetron. Also, some containers made of metal are known to cause arcing between the container and other metal objects in the oven, including the oven walls.

Of course, alternatives are known to microwave cooking, but each other approach has its drawbacks. For instance, electric and gas convection ovens take a much longer time to heat the materials placed therein. Electric warming dishes have limited mobility (relative proximity to wall socket locations) and food warming fuels have potential fire risks.

To date, applicant is aware of no products which provide a microwave safe metal composition for receiving a sufficient amount of dielectric energy in a short time and providing a long period of thermal conductive release onto an adjacent foodstuff or food container for provided needed warming in culinary preparation and presentation without melting and without harming the user or preparer.

What is needed is a mechanism for a di-electric heatable material for promptly delivering a prolonged yet modulated level of heat to a utensil, dish, foodstuff or cooking container.

### Definition of Terms

The following terms are used in the claims of the patent as filed and are intended to have their broadest plain and ordinary meaning consistent with the requirements of the law:

An effective amount of heat comprises a temperature of at least 120 F on the surface of the outer wall for at least 15 minutes when timed after removal from a microwave.

A cooking implement is a utensil, container or support structure for conductively heating a container, dish or foodstuff.

Where alternative meanings are possible, the broadest meaning is intended. All words used in the claims set forth below are intended to be used in the normal, customary usage of grammar and the English language.

### SUMMARY OF THE INVENTION

The present invention relates to one or more of the following features, elements or combinations thereof.

One first embodiment is directed to the use of a cooking implement comprising at least two different layers. Specifically, this embodiment includes a first layer of hardened plastic (such as polypropylene or HDPE), preferably with an over-mold of a thermoplastic elastomer (TPE) mixed with a microwave active material or conductor such as graphite or a powdered alloy. The use of graphite, iron, copper, ceramic or similar conductive alloy within the overmold is believed to provide a thermal bleed or modulated delivery of a therapeutic amount of heat to the foodstuff, plate or container.

Other variants of this first embodiment includes a first layer or portion made of a microwave inert material such as HDPE, polypropylene, silicone or PET, wherein such outer layer includes a powdered metallic material or carbon black/graphite or the like in a range of 10-30% so as to create a microwave absorbable material, and an second layer or portion comprising an overmold that includes an Thermoplastic Elastomer or Thermoplastic Urethane, such as Santoprene or TIPSiV, wherein such second layer may or may not include similar microwave absorbable material. This embodiment is believed to provide an assembly with superior performance for absorbing microwave thermal energy quickly, while at the same time providing a slow thermal bleed so as to enable delivery of an effective amount of heat to the foodstuff, container, or dish. As a further variant upon this first embodiment, this embodiment can also include the use of a matrix or lattice in the otherwise air filled core inside of the overmold component (if the form factor permits) so as to improve the performance of the thermal bleed.

A second disclosed embodiment is directed to the use of a single thermoelastomer layer (e.g. polypropylene, polyethylene, or similar materials) with microwave activated material (e.g. carbon black) that heat up in a consumer microwave.

The form factors for such compositions include knives (e.g., to provide a heated blade for better cutting performance), spoons (e.g., heated ice cream spoons or scoops to ease the serving of ice cream), a heating dish (for heating a food tray for a buffet style placement), a support dish (e.g., for holding a paper plate and warming the contents thereon), or even a cup.

Thus, it can be seen that one object of the disclosed invention is to provide a material which can safely absorb di-electric energy in a relatively short time, while bleeding such energy to a dish, container or foodstuff for a longer or more sustained period of time.

A further object of the invention is to provide a composition for a structure that provides a conductive heat source for warming foodstuffs, containers and dishes that does not require an active electrical connection or flame.

Still another object of the present invention is to provide a conductive heat source for warming foodstuffs, containers and dishes that does not melt or harm the user.

It should be noted that not every embodiment of the claimed invention will accomplish each of the objects of the invention set forth above. For instance, certain claimed embodiments of the invention will not employ a dish, per se, but rather may a support structure or stand to delivery heat to the surface of the dish for keeping the food warm. In addition, further objects of the invention will become apparent based upon the summary of the invention, the detailed description of preferred embodiments, and as illustrated in the accompanying drawings. Such objects, features, and advantages of the present invention will become more apparent in light of the following detailed description of various preferred embodiments thereof, and as illustrated in the accompanying drawings.

### BRIEF DESCRIPTION OF THE DRAWINGS

FIG. 1a is an perspective view of heating support dish assembly form factor in accord with a first preferred embodiment of the present invention;

FIG. 1b is a cut away side view of the heating support dish of FIG. 1a.

FIGS. 2a and 2b are top and side views of a knife/utensil form factor in accord with another preferred embodiment of the invention;

FIG. 3 is a perspective view of a cup form factor in accord with another preferred embodiment of the invention;

FIG. 4 is a perspective view is a perspective view warming tray form factor in accord with another preferred embodiment of the invention; and

FIG. 5 is a perspective view of a warming support plate form factor assembly in accord with another preferred embodiment of the invention.

### DETAILED DESCRIPTION OF EMBODIMENTS OF THE INVENTION

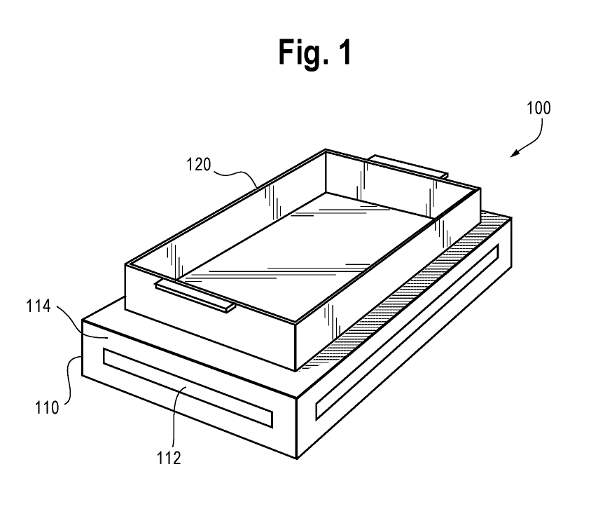

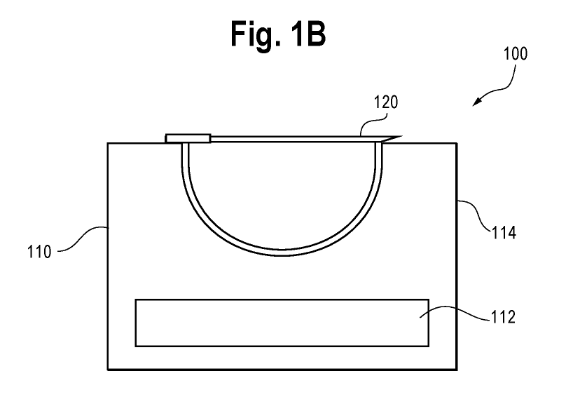

As can be seen in FIG. 1, one embodiment of the present invention comprises a warming assembly 100 comprising a warming tray 110 and a dish 120, such as a casserole dish. The warming tray 110 is most preferably of small enough dimensions to be placed in conventional microwave oven chambers. Additionally, those of skill in the art will understand that the dish 20 may be composed of glass, silicone or a similar, microwave safe material that allows the safe retention of heat for foodstuffs.

In a first preferred embodiment, the warming tray 110 includes a first thermoplastic layer 112 preferably made of a rigid, strong yet lightweight material, such as HDPE, silicone or polypropylene, or other alternatives such as described above. Also included in this embodiment is a second thermoplastic layer 114 made of a thermoplastic elastomer mixed with a conductor such as graphite or a powdered alloy. An example of this mixture may be found, for example in Santoprene, PRE-ELEC 1502 or in Preseal TPE 5010, or which is available through Premix Thermoplastics, Inc. This second thermoplastic layer is overmolded onto the surface of the first layer, and the graphite or metallic coated graphite or similar conductor in that second layer better enables the quick and controllable conduction of heat from the microwave through the dish 120 to provide a sustained about of heat (at least 120 degrees Fahrenheit for at least 15 minutes) after being placed in a microwave for only ½ to 2 minutes.

The first layer 112 or portion of the warming tray 110 preferably includes a thickness of between about 1/16″-1″ of polypropylene or similar material mixed with about 10-30% by weight carbon black so as to absorb microwave energy, with a second overmolded layer 114 or portion of up to ½″ in thickness that is a mixture of Santoprene impregnated or mixed with about 10-30% by weight carbon black so as to absorb microwave energy, though the second layer may optionally be inert. The combination of these layers and their varying thermal coefficients are thus believed to provide for the quick accumulation of microwave energy to heat the tray 110, while still slowly bleeding that thermal energy back through the second portion or layer so as to provide a modulated delivery of heat to the dish for application to the foodstuffs.

As shown in FIG. 1b, this preferred embodiment provides for the first portion or layer 112 to be encapsulated within the overmold portion or layer 114. This provides the ability of the surface temperature of the overmold layer 114 to actually increase over a period of minutes after been removed from the microwave (e.g., 3-5 minutes) to provide a prolonged delivery of an effective amount of heat from the first layer 112 through the overmold layer 114 to the dish. A variant of this first embodiment would be to have a side of the first layer 112 open or uncovered by the overmold layer 114 so as to more promptly deliver its heat load to an adjacent dish 120 or a thermally conductive ceramic or glass layer (not shown).

In a second preferred embodiment, the warming dish 110 may comprise a single layer 112 corresponding to the second layer identified above. It should be noted that in various embodiments, this assembly may involve versions whereby the warming dish 110 alone is placed in the microwave for keeping the dish 120 warm after the dish 120 is removed from an oven or some other cooking source. Thus, the method of the use of the present invention can involve the steps of heating a warming dish 110 in a microwave oven for about 30 seconds to 2 minutes, placing the dish in a food station where the first layer begins to further heat the conductive surface of the warming dish to a warmer temperature than when the microwave stopped, and then placing the dish 120 in the warming dish 110 for receiving an effective amount of heat. This method has the benefits of (among other things) allowing a user to remove and place the warming dish 100 before its surface achieves its highest temperature (so as to lessen risk to the user), as well as providing the effective deliver of heat to the dish 120 for a much longer period than the time for which the warming dish was placed in the microwave.

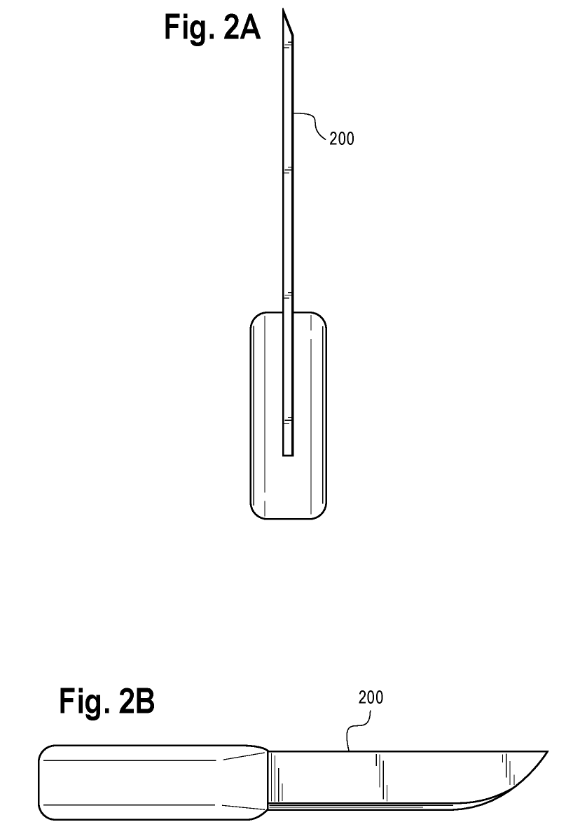

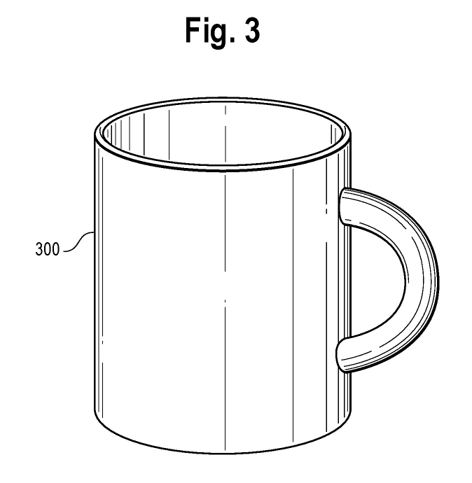

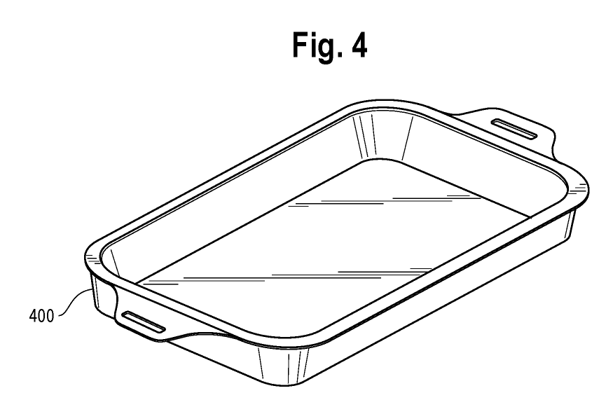

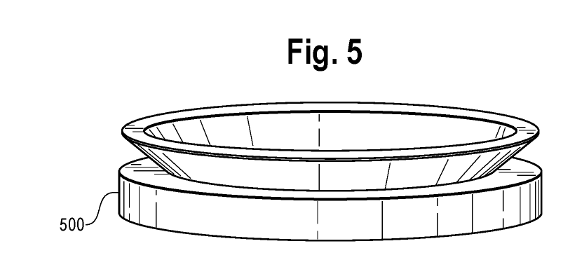

Still other form factors can be understood from this disclosure, and with reference to FIGS. 2-5. Such form factors can include: knives 200 (e.g., to provide a heated blade for better cutting performance); a cup 300; a serving tray 400; or a dish assembly 500 including a support dish 510 for holding a paper plate or the like.

While the disclosure is susceptible to various modifications and alternative forms, specific exemplary embodiments thereof have been shown by way of example in the drawings and have herein been described in detail. It should be understood, For instance, there is a number of variants on the form factors involved, and there is no intent to limit the disclosure to the particular embodiments disclosed, but on the contrary, the intention is to cover all modifications, equivalents, and alternatives falling within the spirit and scope of the disclosure as defined by the appended claims.

What is claimed is:

1. A cooking implement including at least a first thermoplastic elastomer layer, the thermoplastic elastomer being mixed with a microwave activated material comprising about 10-30% by weight of the first thermoplastic elastomer layer so as to absorb energy from a dielectric source so as to a deliver an effective amount of heat to a foodstuff or foodstuff container.

2. The cooking implement of claim 1, wherein the thermoplastic elastomer of the first thermoplastic elastomer layer is HDPE.

3. The cooking implement of claim 1, wherein the thermoplastic elastomer of the first thermoplastic elastomer layer is silicone.

4. The cooking implement of claim 1, wherein the thermoplastic elastomer of the first thermoplastic elastomer layer is PET.

5. The cooking implement of claim 1, wherein the microwave activated material is graphite.

6. A cooking implement including at least a first thermoplastic elastomer layer and a second overmold plastic layer, the first thermoplastic elastomer being mixed with a microwave activated material comprising about 10-30% by weight of the first thermoplastic elastomer layer so as to absorb energy from a dielectric source so as to a deliver an effective amount of heat to a foodstuff or foodstuff container.

7. The cooking implement of claim 6, wherein the thermoplastic elastomer of the first thermoplastic elastomer layer is polypropylene.

8. The cooking implement of claim 6, wherein the thermoplastic elastomer of the first thermoplastic elastomer layer is silicone.

9. The cooking implement of claim 6, wherein the thermoplastic elastomer of the first thermoplastic elastomer layer is PET.

10. The cooking implement of claim 6, wherein second overmold plastic layer is Santoprene.

11. The cooking implement of claim 6, wherein the thermoplastic elastomer of the first thermoplastic elastomer layer is TipSiv.

12. The cooking implement of claim 6, wherein the microwave activated material is graphite.

13. A cooking implement including at least a first thermoplastic elastomer layer and a second overmold plastic layer, the first thermoplastic elastomer being mixed with a microwave activated material comprising about 10-30% by weight of the first thermoplastic elastomer layer, and the second overmold plastic layer is mixed with a microwave activated material comprising about 10-30% by weight of the second overmold layer so as to absorb energy from a dielectric source so as to a deliver an effective amount of heat to a foodstuff or foodstuff container.

14. The cooking implement of claim 13, wherein the thermoplastic elastomer of the first thermoplastic elastomer layer is HDPE.

15. The cooking implement of claim 13, wherein the thermoplastic elastomer of the first thermoplastic elastomer layer is silicone.

16. The cooking implement of claim 13, wherein the thermoplastic elastomer of the first thermoplastic elastomer layer is PET.

17. The cooking implement of claim 13, wherein second overmold plastic layer is Santoprene.

18. The cooking implement of claim 13, wherein the thermoplastic elastomer of the first thermoplastic elastomer layer is TipSiv.

19. The cooking implement of claim 13, wherein the microwave activated material is graphite.
